(19) United States
(12) Patent Application Publication
(10) Pub. No.: US 2011/0112692 A1
(43) Pub. Date: May 12, 2011

(54) SYSTEM FOR REMOTE CONTROL OF PACKAGED TERMINAL AIR CONDITIONER AND HEATERS WITH WIRELESS REMOTE CONTROL SYSTEMS

(75) Inventor: Tat Keung CHAN, South San Francisco, CA (US)

(73) Assignee: Jetlun Corporation, South San Francisco, CA (US)

(21) Appl. No.: 12/942,953

(22) Filed: Nov. 9, 2010

Related U.S. Application Data
(60) Provisional application No. 61/259,992, filed on Nov. 10, 2009.
(60) Provisional application No. 61/259,789, filed on Nov. 10, 2009.

(51) Int. Cl. G05D 23/19; H04B 10/00; H04B 7/00

(52) U.S. Cl. 700/276; 236/1 C; 398/130; 455/66.1

(57) ABSTRACT

An air conditioning/heating apparatus. The apparatus includes a housing and an occupancy sensor coupled to the housing. The apparatus also includes a wireless module coupled to the occupancy sensor and a powerline appliance coupled to a powerline network. In a preferred embodiment, the powerline module is configured to communicate with the wireless module.

### CROSS-REFERENCES TO RELATED APPLICATIONS

This present application claims priority to U.S. Provisional Application No: 61/259,789 filed Nov. 10, 2009 and U.S. Provisional Application No: 61/259,992 filed Nov. 10, 2009, commonly assigned, and hereby incorporated by reference herein.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to the energy monitoring techniques. In particular, the present invention provides remote control of packaged terminal air conditioners (PTAC) and heaters with wireless remote control systems. More particularly, the invention provides a method and system for communicating and controlling with an air conditioner or heater using wireless techniques (e.g., Zigbee™), but it would be recognized that the invention has a much broader range of applications. Additionally, the other networking techniques include Bluetooth, UWB, 6LoWPAN, 802.11 Wi-Fi, and other combinations.

A packaged terminal air conditioning unit, commonly called PTAC, is a type of self-contained air conditioning and heating system commonly found in offices, hotels, and apartment buildings. Often times, the PTAC is used when it is either impractical or prohibitive to install a central heating ventilation air conditioning system. Many conventional PTACs are designed to go through a wall, having vents and heat sinks both inside and outside. More recent versions of PTACs are now ductless and do not generally require to be placed in a window. Conventional controls for PTACs were normally placed on the surface of the unit, which made it challenging to operate when the PTAC is placed at a high low, or awkward position in the room.

More recently, PTACs are designed to work with a wireless remote control system that provides the operator the freedom of movement while controlling the room air conditioner. The wireless remote control system often utilizes a microprocessor for transmitting and operating data to an air conditioner and a receiving circuit for receiving data from the air conditioner relating to its operation (e.g., on/off, temperature settings, up/down directional fan buttons, airflow direction, fan speed, temperature setting, timer operation etc.). Limitations, however, exist with conventional PTACs.

In the event that the operator loses the wireless remote control system or left the air conditioner unattended, conventional wireless remote controls do not provide the operator any means for remote/off-premise control. In commercial settings such as hotels where there are many PTACs throughout a building, it is challenging for the hotel operator to eliminate energy waste and costs derived from PTACs that are left on and generally unattended. These and other limitations are described throughout the present specification and more particularly below.

From the above, it is seen that techniques for remote control of PTACs and heaters is highly desirable.

### BRIEF SUMMARY OF THE INVENTION

According to the present invention, techniques for energy monitoring are provided. More particularly, the present invention may be embodied as a system for remote control of PTAC and heaters with a wireless remote control system in one or more embodiments. The system includes an integrated wireless module and a small magnet adhesive or other attachment means. The system further includes a local area network for communicating with a gateway master control station that can connect to the World Wide Web (WWW) or Advanced Metering Infrastructure (AMI) or an external data source to allow remote monitoring and control of the network, and specifically, the PTAC. Of course, there can be other variations, modifications, and alternatives.

In a specific embodiment, the present invention provides a system for remote monitoring and remote controlling of the operational state of the PTAC in, for example, a home, building, apartments, hospitals, schools, factories, office buildings, industrial area settings and other regions.

In a specific embodiment, the present invention provides an air conditioning/heating apparatus. The apparatus includes a housing and an occupancy sensor coupled to the housing. The apparatus also includes a wireless module coupled to the occupancy sensor and a powerline appliance coupled to a powerline network, which is configured to communicate with the wireless module.

In an alternative specific embodiment, the present invention provides a method for linking a remote air conditioning/heating unit. The method includes transferring a first signal in an infrared format from a remote device to a remote air conditioning/heating unit. The method also includes transferring a second signal in a Zigbee format to an appliance module and processing the Zigbee format to a powerline signal format for transmission over one or more powerline networks. In a specific embodiment, the one or more powerline networks is coupled to one or more gateway devices.

In an alternative embodiment, the present invention provides a method for communicating with a remote air conditioning/heating unit. The method includes transferring a first signal in a first wireless format from a remote device to a remote air conditioning/heating unit and transferring a second signal in second wireless format to an appliance module according to a specific embodiment. The method also includes processing the second signal in the second format to a transport format for transmission over one or more networks. The one or more networks is coupled to one or more gateway devices.

Still further, the present invention provides a remote air conditioning/heating unit. The unit includes an air conditioning/heating unit having a housing structure and a wireless module coupled to an exterior region of the housing structure. The wireless module is configured to communicate to one or more powerline networks.

Moreover, the present invention provides a method of operating an air conditioning/heating unit. The method includes transferring a powerline signal in a first format from an external network coupled to a world wide network of computers, transferring a first wireless signal in a Zigbee format to a module coupled to the air conditioning/heating unit, and detecting information from the first wireless signal. The method also includes performing one of a plurality of operations selected from at least an ON or OFF of the air conditioning unit.

The above mentioned and other features and objects of this invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 is a simplified block diagram of the integrated wireless Module according to the embodiment of the present invention;

FIG. 2 is a simplified perspective view of a method of installing a wireless module and the magnetic adhesive to an air conditioner according to the embodiment of the present invention;

FIG. 3 is a simplified diagram of the system according to the embodiment of the present invention;

FIG. 4 is an alternative simplified diagram of the system according to the embodiment of the present invention;

FIG. 5 is a simplified setup flow diagram of the system according to the embodiment of the present invention;

FIG. 6 is a simplified operational state flow diagram of the system according to the embodiment of the present invention; and

FIG. 7 is a simplified flow diagram of operating the system using an alternative internal timing process according to the embodiment of the present invention.

### DETAILED DESCRIPTION OF THE INVENTION

According to the present invention, techniques related generally to the remote control of packaged terminal air conditioners (PTAC) and heaters with wireless remote control systems are provided. More particularly, the invention provides a method and system for communicating and controlling with an air conditioner or heater using Zigbee wireless techniques, but it would be recognized that the invention has a much broader range of applications. Additionally, the other networking techniques include Bluetooth, UWB, 6LoWPAN, 802.11 Wi-Fi, and other combinations. Additionally, the embodiments described are explained in terms of a Zigbee format, but other formats can also be used. That is, the term “Zigbee” is not intended to be limited to solely the Zigbee format. Additionally, the term ZigBee is commonly defined as “a specification for a suite of high level communication protocols using small, low-power digital radios based on the IEEE 802.15.4-2003 standard for wireless personal area networks (WPANs), such as wireless headphones connecting with cell phones via short-range radio.” “The technology defined by the ZigBee specification is intended to be simpler and less expensive than other WPANs, such as Bluetooth. ZigBee is targeted at radio-frequency (RF) applications that require a low data rate, long battery life, and secure networking.” See, www.wikipedia.org/wiki/zigbee/ Of course, there can be other variations, modifications, and alternatives.

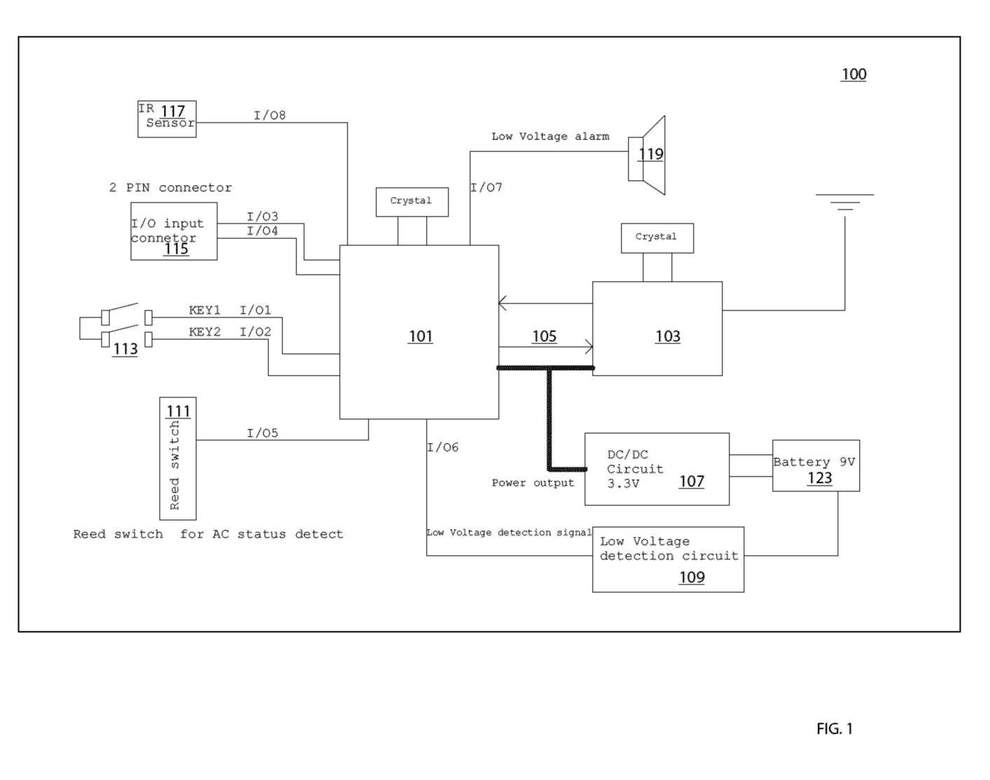

FIG. 1 is a block diagram of the integrated wireless module according to the embodiment of the present invention. This diagram is merely an example, which should not unduly limit the scope of the claims herein. One of ordinary skill in the art would recognize other variations, modifications, and alternatives. As shown, a block diagram 100 of the integrated wireless module is included. In a specific embodiment, the module is enclosed in a housing, which is made of durable plastic or other non-conductive material. The housing includes a printed circuit board with the elements noted herein. In a specific embodiment, the housing has a thickness of less than one inch, a length of less than three inches, and a width of less than three inches, but can be other configurations. In a specific embodiment, the housing includes multiple LED indicators, which couple to the CPU or internal components. The housing also includes an opening for a plurality of mechanical switches for programming or other functions. Additionally, the housing includes other openings for I/O's, which have been described further and more particularly below. In a preferred embodiment, the housing includes a fastening region, which couples to the wall or PTAC or other appliance. In a specific embodiment, the housing includes LEDs, I/O, fastener, key switches, and other elements. Of course, there can be other variations, modifications, and alternatives.

In a specific embodiment, the block diagram 100 has a central processor unit (CPU) 101 that is connected to a Zigbee module 103 through a universal asynchronous receiver/transmitter (UART) 105 to RS232 or other serial port or the like. In a specific embodiment, the CPU is a suitable microprocessor or controller, such as an 8 Bit STM8H6189-TAKITY manufactured by STMicroelectronics or other manufacturers. In a specific embodiment, the CPU includes one or more memory devices. Such memory devices can be configured to store one or more codes directed to turning ON/OFF the air conditioning from a remote infrared transmitting device or the like.

In as an example, the Zigbee module is an EM250 or EM357 manufactured by Ember Corporation in the U.S. or other like designs manufactured by Texas Instruments Incorporated, Freescale Semiconductor, and others. As an example, the Zigbee module comprise an antenna for wireless communication, a crystal for providing signals to the Zigbee module, and communication interfaces, as noted. Of course, there can be other variations, modifications, and alternatives. The CPU 101 is also connected to a DC/DC circuitry 107, a low voltage detection circuit 109, a reed switch 111, a key for remote control 113, an input connector 115, an Infrared (IR) sensor 117, and a low voltage alarm 119 through an I/O 121. Further details of these elements can be found throughout the present specification and more particularly below.

In a specific embodiment, the DC/DC circuitry 107 is connected to a 9V battery 123 that is connected to the low voltage detection circuit 109, which detects a voltage of the 9V battery. In a preferred embodiment, the low voltage detection circuit indicates a low voltage of the battery and sends an alarm signal such as a flash LED 119 or other indication. In a specific embodiment, low voltage is indicated by an indication in the LED and a very low voltage may be indicated by a combination of the LED signal and acoustic alarm signal. The very low voltage signal is often used to signal the user to change the battery, which should be replaced. Of course, there can be other variations, modifications, and alternatives. In a specific embodiment, the DC/DC circuitry provides power to the CPU and the Zigbee module and converts the 9V to 3.3V or other suitable voltage or conversion. Of course, there can be other variations, modifications, and alternatives.

In a specific embodiment, the CPU is coupled to the sensor 117. In a specific embodiment, the IR sensor is configured to communicate to the appliance or receiver coupled to the appliance. In a specific embodiment, the IR sensor is configured to receive one or more codes from a remote IR transmitting device. Once the IR sensor receives the one or more codes, such codes are stored in memory coupled to the CPU, microcontroller, or the like. In a specific embodiment, the CPU is also coupled to a switch 111, which detects a status of the air conditioning appliance. That is, the switch may be a reed switch configured to detect whether the air conditioning is in an ON state or OFF state. The reed switch is coupled to one or more of the louvers, which move up and down, and translate such motion to the reed switch according to a specific embodiment. Signals from the reed switch are transferred to the CPU to detect whether the air conditioning is in the ON or OFF state. As an example, the “reed switch contains a pair (or more) of magnetizable, flexible, metal reeds whose end portions are separated by a small gap when the switch is open” as explained by http://en.wikipedia.org/wiki/Reed switch, or other ordinary meanings “The reeds are hermetically sealed in opposite ends of a tubular glass envelope.” Of course, there can be other variations, modifications, and alternatives.

In a specific embodiment, I/O input connector 115 can be configured with any type of sensing device. Such sensing device can include those for lighting, air flow, humidity, occupancy, ON/OFF, other temperature, motion, or other external or internal monitoring process or the like. Key 113 also can also be used to read the RF code or the like. Of course, there can be other variations, modifications, and alternatives.

In a specific embodiment, the infrared sensor is configured to detect human users. That is, the sensor detects heat from one or more users within a vicinity of the system or spatial region. The sensor can also be replaced by other types of sensors capable of detecting the presence of the user. Examples of such sensors include infrared, acoustic, motion, combinations, and others. In a specific embodiment, the sensor can be configured through I/O input connector coupled to the CPU or the like. Of course, there can be other variations, modifications, and alternatives.

In still a further embodiment, the wireless module also includes a temperature sensor. The temperature sensor is integrated in the CPU, but can also be separate or at other preferred locations. As an example, the integrated temperature sensor is embedded in the CPU, which can detect the temperature of the CPU and external regions. In a specific embodiment, the temperature is detected for ambient conditions, heating/cooling unit, and other parameters, as well as other applications. Of course, there can be other variations, modifications, and alternatives.

In yet another embodiment, the reed switch is coupled to the flaps (e.g., louvers) to detect whether they are in one of a plurality of states. The states include open/closed/moving, and any combination of these. In a specific embodiment, the reed switch is placed spatially within a vicinity of one or more of the flaps, which often move together according to one or more embodiments. Of course, there can be other variations, modifications, and alternatives.

In yet other embodiments, the module also includes other sensor devices. In one or more embodiments, the other sensor devices can be used to detect sound, vibration, smoke, air quality, carbon content, smell, and other conditions whether extrinsic or intrinsic. Of course, there can be other variations, modifications, and alternatives.

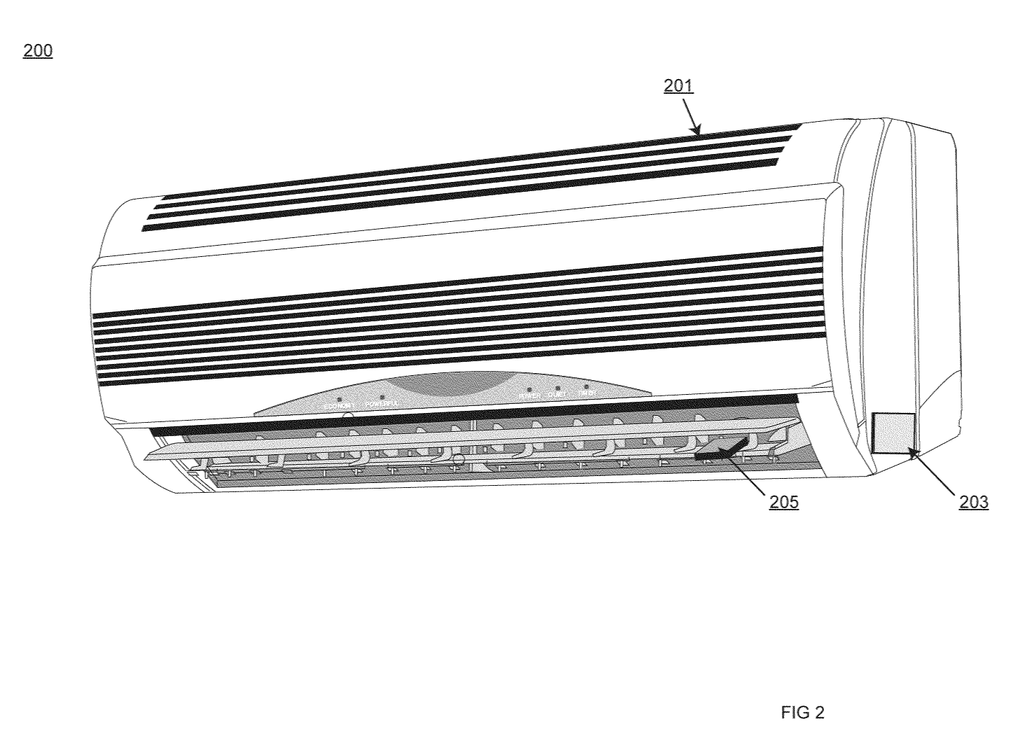

FIG. 2 is a perspective view of a method of installing a wireless module and the magnetic adhesive to an air conditioner according to the embodiment of the present invention. This diagram is merely an example, which should not unduly limit the scope of the claims herein. One of ordinary skill in the art would recognize other variations, modifications, and alternatives. As shown, the integrated wireless module 203 is adhered to the packaged air conditioning unit 201. A small magnetic strip 205 is placed on the air flow vents 207.

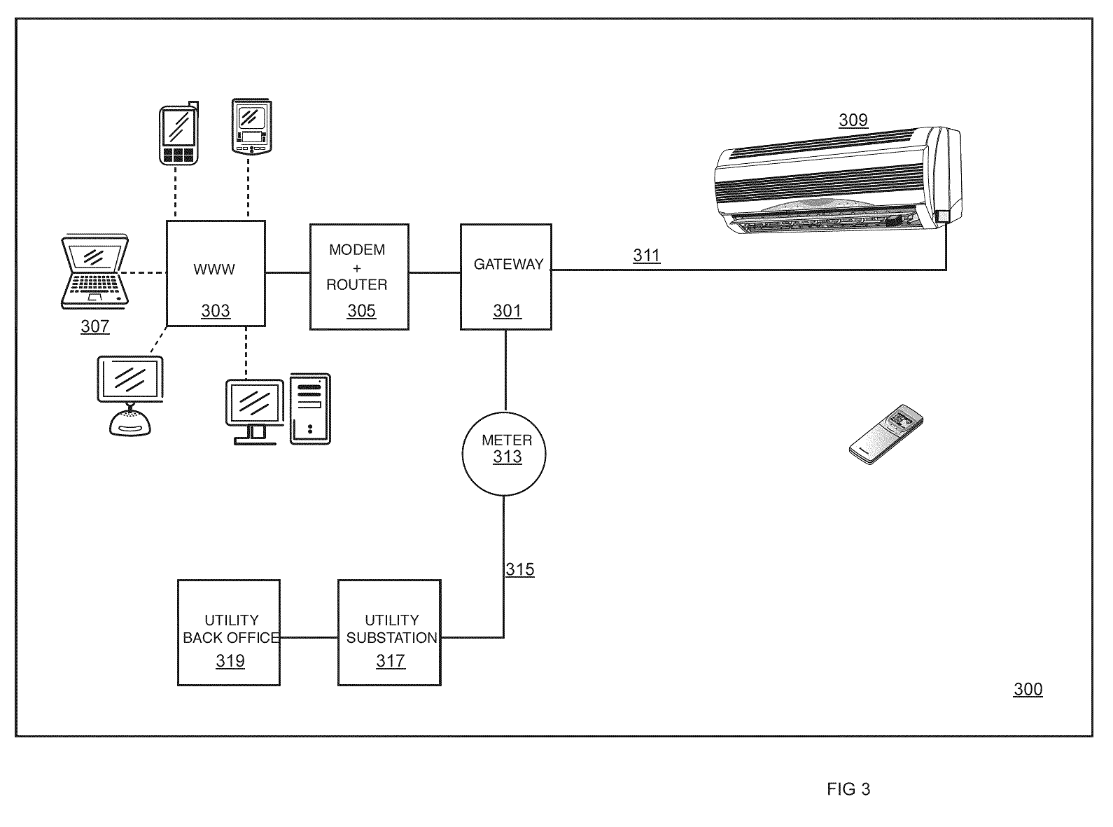

FIG. 3 is a simplified diagram of the system according to the embodiment of the present invention. This diagram is merely an example, which should not unduly limit the scope of the claims herein. One of ordinary skill in the art would recognize other variations, modifications, and alternatives. As shown, the system 300 has a gateway 301 that is coupled to the external data source 303, which is derived from a modem or router 305 that connects to a world-wide network of computers or world-wide web (WWW) 303 and provides multiple IP addresses to the system 300, and is then coupled to a plurality of package terminal air conditioner 309 wirelessly 311. A plurality of computing devices and mobile devices 307 can monitor and control the gateway 301 and client devices residing behind the gateway. The gateway 301 can also be connected to a Smart Meter 313 either through AC wiring or wirelessly 315 to the utility Substation 317 and to a utility back office 319. An example of a gateway device can be found in “METHOD AND SYSTEM FOR INTELLIGENT ENERGY NETWORK MANAGEMENT CONTROL SYSTEM,” filed Aug. 30, 2009 and listed as U.S. Ser. No. 12/550,382, commonly assigned, and hereby incorporated by reference herein. Of course, there can be other variations, modifications, and alternatives.

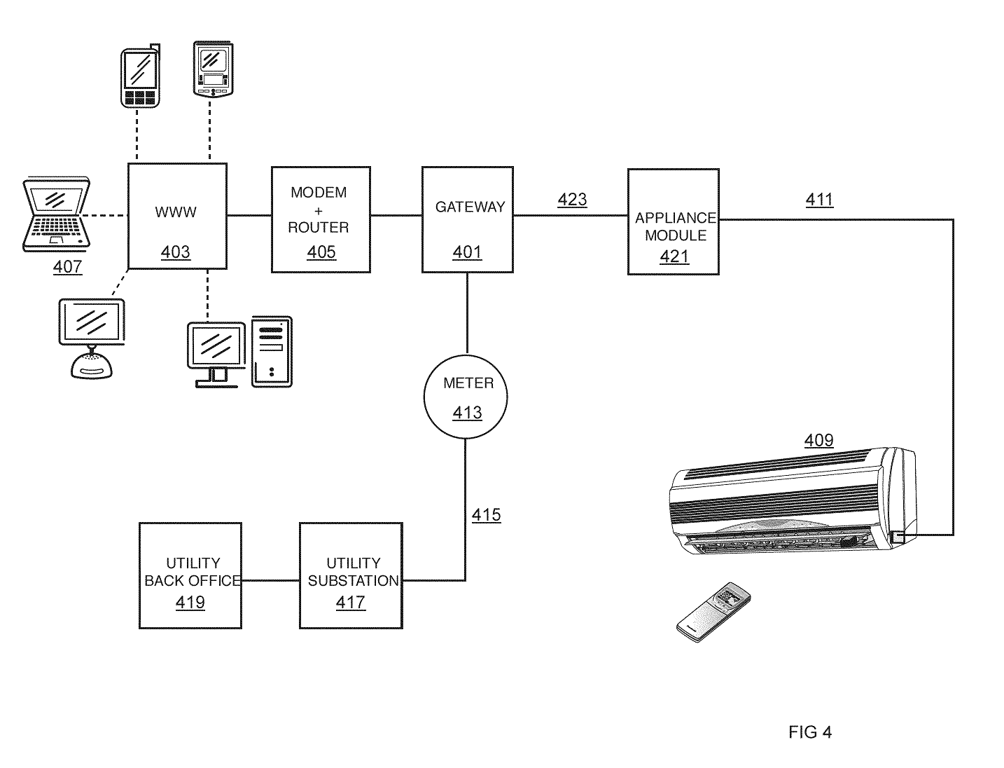

FIG. 4 is an alternative simplified diagram of the system according to the embodiment of the present invention. This diagram is merely an example, which should not unduly limit the scope of the claims herein. One of ordinary skill in the art would recognize other variations, modifications, and alternatives. As shown, the system 400 has a gateway 401 that is coupled to the external data source 403, which is derived from a modem or router 405 that connects to a world-wide network of computers or world-wide web (WWW) 403 and provides multiple IP addresses to the system 400, and is then coupled to a plurality of package terminal air conditioner 409 wirelessly 411 through an Appliance Module 421 that is connected to the Gateway 401 through the AC wiring 423. A plurality of computing devices and mobile devices 407 can monitor and control the gateway 401 and client devices residing behind the gateway. The gateway 401 can also be connected to a Smart Meter 413 either through AC wiring or wirelessly 415 to the utility Substation 417 and to a utility back office 419.

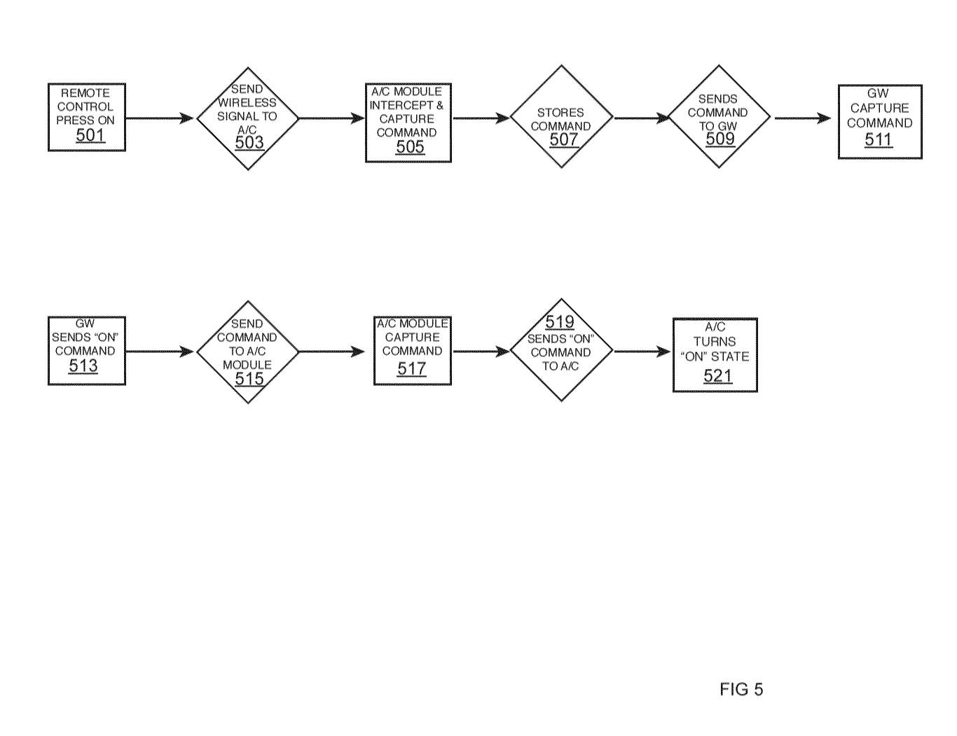

FIG. 5 is a simplified setup flow diagram of the system according to the embodiment of the present invention. This diagram is merely an example, which should not unduly limit the scope of the claims herein. One of ordinary skill in the art would recognize other variations, modifications, and alternatives. As shown, the setup flow diagram starts by pressing ON on the remote control 501, which then sends a Zigbee wireless signal to the PTAC 503. The A/C module captures the command 505, store it 507, sends the command to the Gateway 509 and is stored in the Gateway 511. In a specific embodiment, the remote control 501 sends a wireless infrared signal 503 to the PTAC. As an example, the infrared signal is a plurality of pulses in 38 kHz but can be others. The module intercepts 505 the infrared signal 505 and stores 509 one or more codes (e.g., binary code, digital code) associated with the signal into memory of the CPU. In a specific embodiment, the memory is a solid state semiconductor memory such as flash, or others. The code or command is then sent to the gateway. In a preferred embodiment, the above sequence of steps or process is used to teach or learn the code or command by the gateway, which is coupled to wirelessly, powerline, or other network, alone or in combination to the wireless module that is coupled to the PTAC. Of course, there can be other variations, modifications, and alternatives.

To control the PTAC through the network, a user shall log into the gateway to press the ON command 513, which then send the command at least wirelessly to the A/C module 515. The A/C module then captures the command 517 and relays the command to the PTAC 519 and the PTAC turns to the ON state 521. In a specific embodiment, the gateway communications to the A/C module via one or more networks including wireless, wired, powerline, or others between the gateway and the A/C module. Of course, there can be other variations, modifications, and alternatives.

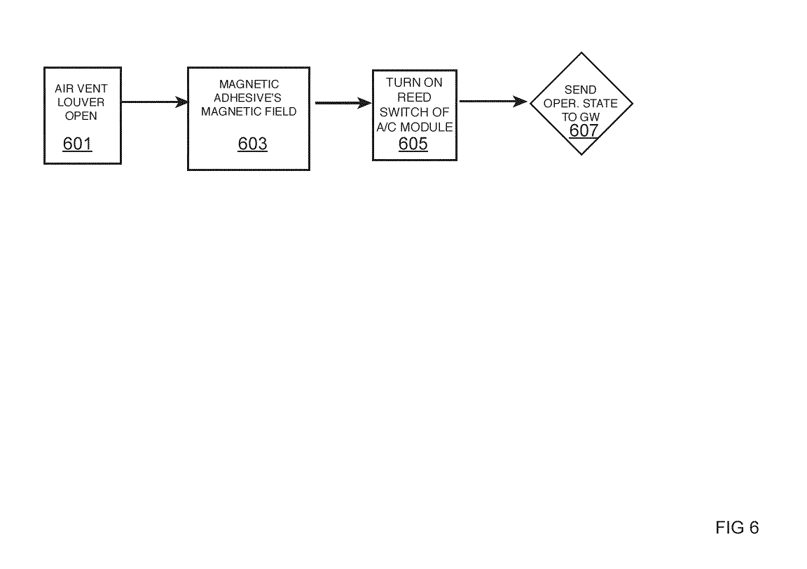

FIG. 6 is a simplified operational state flow diagram of the system according to the embodiment of the present invention. This diagram is merely an example, which should not unduly limit the scope of the claims herein. One of ordinary skill in the art would recognize other variations, modifications, and alternatives. As shown, the air vent louver is on the “Open” state 601 which pulls the magnetic adhesive's magnetic field 603 and turns on the Reed Switch of the A/C Module 605, which then sends the operation state to the gateway 607. Of course, there can be other variations, modifications, and alternatives.

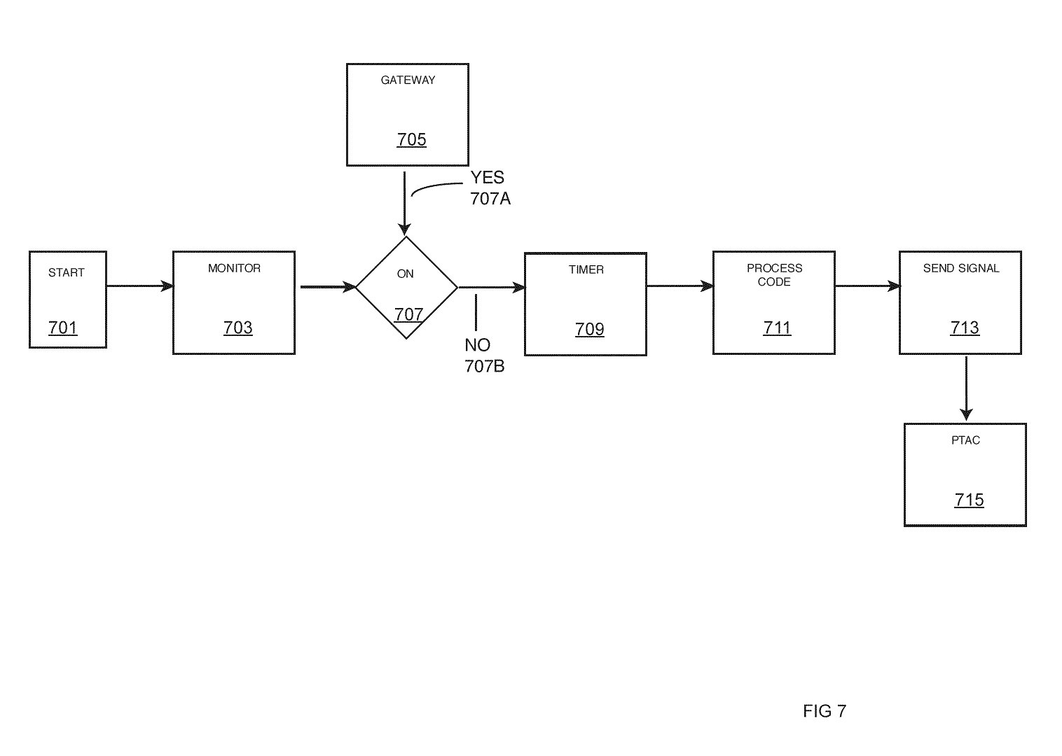

In a specific embodiment, a method may be outlined below, as referenced by FIG. 7.
1. Start, step 701;
2. Monitor PTAC, step 703;
3. Determine status of gateway, step 707;
4. Gateway controls PTAC, via branch 707A, step 705;
5. Timer controls PTAC, via branch 707B, step 709;
6. CPU retrieves command code from memory, step 711;
7. Command transmitted (step 713) from A/C module to PTAC;
8. PTAC (step 715) receives command code to turn ON or OFF the PTAC;
9. Perform other steps, as desired; and
10. Stop.

As shown, the above sequence of steps provides one or more processes to use the command code or codes stored in memory of the CPU in the A/C module according to a specific embodiment. In a preferred embodiment, the command code stored in memory is transmitted via timing process, which turns the PTAC ON or OFF depending upon a pre-programmed timing sequence, when the gateway has been disconnected and/or disrupted and cannot communicate to the PTAC. In a specific embodiment, the battery power in the A/C module can be used to perform any of the above operation, when the gateway has been disconnected or disrupted. In one or more embodiments, the steps above may be further combined and/or separated. In other embodiments, steps can be removed or added. Of course, there can be other variations, modifications, and alternatives.

FIG. 7 is a simplified flow diagram of operating the system using an alternative internal timing process according to the embodiment of the present invention. This diagram is merely an example, which should not unduly limit the scope of the claims herein. One of ordinary skill in the art would recognize other variations, modifications, and alternatives. As shown, the method begins at start, step 701. The method performs a process of monitoring the PTAC, step 703, according to a specific embodiment. The method determines a status of gateway, step 707, whether the gateway is communicating with the PTAC or disrupted or disconnected. In a preferred embodiment, the gateway monitors and provides control to the PTAC, via branch 707A, step 705. In an alternative embodiment, when the gateway has been disconnected or disrupted, the method uses an internal timing process in the A/C module using a timer to control the PTAC, via branch 707B, step 709. That is, the CPU provides instructions to retrieve the stored codes or commands from memory, step 711, and transmits, step 713, the codes or command from the A/C module to the PTAC (step 715) to turn it ON or OFF based upon one or more timing sequences of a timing process. Of course, there can also be other steps, which are introduced or removed. Of course, one of ordinary skill in the art would recognize other variations, modifications, and alternatives.

As shown, the above sequence of steps provides one or more processes to use the command code or codes stored in memory of the CPU in the A/C module according to a specific embodiment. In a preferred embodiment, the command code stored in memory is transmitted via timing process, which turns the PTAC ON or OFF depending upon a pre-programmed timing sequence, when the gateway has been disconnected and/or disrupted and cannot communicate to the PTAC. In a specific embodiment, the battery power in the A/C module can be used to perform any of the above operation, when the gateway has been disconnected or disrupted. In one or more embodiments, the steps above may be further combined and/or separated. In other embodiments, steps can be removed or added. Of course, there can be other variations, modifications, and alternatives.

Although the above has been described in terms of specific embodiments, there can be other variations, modifications, and alternatives. As an example, the present method and system can be applied to any appliance, device, or system capable of communicating with infrared technology, and in particular receives. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for linking a remote air conditioning/heating unit comprising:
transferring a first signal in an infrared format from a remote device to a remote air conditioning/heating unit;
transferring a second signal in a Zigbee format to an appliance module; and
processing the Zigbee format to a powerline signal format for transmission over one or more powerline networks, the one or more powerline networks being coupled to one or more gateway devices.

2. The method of claim 1 wherein the first signal is selected from a start command or a stop command.

3. The method of claim 1 further comprising monitoring a state of the remote air conditioning/heating unit from one or more of the gateway devices or performing a monitoring process using a timing circuit provided in the appliance module if the one or more gateway devices are unconnected.

4. The method of claim 1 further comprising initiating a stop signal from the one or more gateway devices to stop operation of the remote air conditioning/heating unit.

5. The method of claim 1 wherein the first signal is configured in a digital format.

6. The method of claim 1 wherein the remote device is handheld.

7. The method of claim 1 wherein the remote air conditioning/heating unit is configured within a building structure.

8. The method of claim 1 wherein the transferring of the second signal is initiated from the first signal in the infrared format.

9. The method of claim 1 wherein the transferring of the second signal is initiated from the remote device.

10. The method of claim 1 wherein the appliance module comprises a wireless receiver/transmitter coupled to a powerline module, the powerline module being configured to process the second signal in the Zigbee format to the powerline signal format.

11. The method of claim 1 further comprising controlling the remote air conditioning/heating unit from the one or more gateway devices, the one or more gateway devices being coupled to the remote air conditioning/heating unit through at least a world wide network of computers.

12. The method of claim 1 further comprising detecting the first signal from at an infrared module coupled to the air conditioning/heating unit; and then transferring the second signal in the Zigbee format.

13. A method for communicating with a remote air conditioning/heating unit comprising:
transferring a first signal in a first wireless format from a remote device to a remote air conditioning/heating unit;
transferring a second signal in second wireless format to an appliance module; and
processing the second signal in the second format to a transport format for transmission over one or more networks, the one or more networks being coupled to one or more gateway devices.

14. The method of claim 13 wherein the first signal is a start command.

15. The method of claim 13 further comprising monitoring a state of the remote air conditioning/heating unit from one or more of the gateway devices.

16. The method of claim 13 further comprising initiating a stop signal from the one or more gateway devices to stop operation of the remote air conditioning/heating unit.

17. The method of claim 13 wherein the first signal is configured in a digital format.

18. The method of claim 13 wherein the remote device is handheld.

19. The method of claim 13 wherein the remote air conditioning/heating unit is configured within a building structure.

20. The method of claim 13 wherein the transferring of the second signal is initiated from the first signal in the infrared format.

21. The method of claim 13 wherein the transferring of the second signal is initiated from the remote device.

22. The method of claim 13 wherein the appliance module comprises a wireless receiver/transmitter coupled to a module, the module being configured to process the second signal in the first format to the transport format.

23. The method of claim 13 further comprising controlling the remote air conditioning/heating unit from the one or more gateway devices, the one or more gateway devices being coupled to the remote air conditioning/heating unit through at least a world wide network of computers.

24. A remote air conditioning/heating unit comprising:
an air conditioning/heating unit having a housing structure; and
a wireless module coupled to an exterior region of the housing structure, the wireless module being configured to communicate to one or more powerline networks.

25. A method of operating an air conditioning/heating unit comprising:
transferring a powerline signal in a first format from an external network coupled to a world wide network of computers;
transferring a first wireless signal in a Zigbee format to a module coupled to the air conditioning/heating unit;
detecting information from the first wireless signal; and
performing one of a plurality of operations selected from at least an ON or OFF of the air conditioning unit.

26. The method of claim 25 wherein the module comprises a temperature sensor.

27. The method of claim 25 wherein the module comprises a humidity sensor.

28. The method of claim 25 wherein the module comprises an infrared sensor for detecting a presence of one or more human users within a vicinity of the air conditioning unit.

29. The method of claim 25 where the module comprises a Zigbee wireless module.

30. An air conditioning/heating apparatus comprising:
a housing;
an occupancy sensor coupled to the housing;
a wireless module coupled to the occupancy sensor; and
a powerline appliance coupled to a powerline network, the powerline module being configured to communicate with the wireless module.

31. The apparatus of claim 30 wherein the occupancy sensor is at least an infrared sensor, a motion sensor, or an acoustic sensor.
